(19) United States
(12) Patent Application Publication
(10) Pub. No.: US 2004/0206376 A1
(43) Pub. Date: Oct. 21, 2004

(54) Apparatus and a method for cleaning a folding roller

(76) Inventors: Mattias Pernler, Stockholm (SE); Jan Persson, Olofstrom (SE); Timo Ruotsalainen, Kyrkhult (SE)

Correspondence Address: VENABLE, BAETJER, HOWARD AND CIVILETTI, LLP, P.O. BOX 34385, WASHINGTON, DC, 20043-9998, US

(21) Appl. No.: 10/478,869

(22) PCT Filed: May 22, 2002
(86) PCT No.: PCT/SE02/00970

(30) Foreign Application Priority Data
May 28, 2001 (SE) 0101865-4

(51) Int. Cl. B08B 1/02

(52) U.S. Cl. 134/32

(57) ABSTRACT

An apparatus for cleaning a folding roller (2) on a roll folding machine has a capsule with an aperture for insertion of the folding roller (2) and a nozzle which is connected to a high pressure source of a cleaning agent. The nozzle is directed for emitting a jet (32, 33) of the cleaning agent and movement means against the peripheral or circumferential surface of the folding roller (2). In such instance, a relative movement is created between the folding roller (2) and the jet (32, 33) so that the peripheral or circumferential surface will be exposed to the action of the jet 10 (31, 33). A method of cleaning a folding roller (2) in a roll folding machine comprises the steps that the folding roller (2) is passed into a capsule and that the peripheral or circumferential surface of the folding roller (2) is exposed to a jet (32, 33) of cleaning agent under pressure.

### TECHNICAL FIELD

The present invention relates to an apparatus for cleaning a folding roller in a roll folding machine, as well as a method for the same purpose.

### BACKGROUND ART

Roll folding is a common method in sheet metal working, for example within the automotive industry. In the joining together of two workpieces consisting of sheet metal by means of roll folding, the two workpieces are placed on one another on a bed which has exactly the configuration which the finished fold is intended to have. The one workpiece is overdimensioned so that an edge area projects beyond the edge of the second workpiece and this edge area is folded in over the edge area of the second workpiece and is pressed against it. In folding and compressing, a roller is passed along the projecting edge area so that this is gradually given a configurational change up to the above-mentioned final form. This technique is employed, for example, in the production of vehicle doors, fuel caps in motor vehicles, roof hatches and similar components.

In many cases, for increased mechanical strength—but also to prevent corrosion—it is necessary that the space between the sheet metal workpieces lying against one another in the finished fold must be filled with an adhesive or sealant. The adhesive or sealant is applied on one or both of the workpieces before these are laid together. Since there are certain problems inherent in exactly metering the quantity of adhesive or sealant employed, in particular in corner regions of the workpieces where the fold will be narrower than along other edge regions of the workpiece, there is a risk that surplus adhesive or sealant is forced out during the folding operation so that the folding roller employed becomes fouled. This implies a risk that the finished fold will be coated more or less irregularly with adhesive or sealant also on such surfaces which are not intended to have any such coating. In addition, there is naturally the risk that the adhesive or sealant sets on the folding roller so that this can no longer be used with sufficient precision.

### OUTLINE OF THE INVENTION

The present invention has for its object to realise an apparatus and a method for cleaning the folding roller in a roll folding machine so that the roller may thereby be kept clean in association with the roll folding machine.

The objects forming the basis of the present invention will be attained if the apparatus intimate by way of introduction is characterised by a capsule with an aperture for the insertion of the folding roller, a nozzle connected to a high pressure source of cleaning agent, the nozzle being directed so as to emit, at least against the peripheral or circumferential surface of the folding roller, a jet a cleaning agent, and movement means for generating a relative movement between the folding roller and the jet so that, as a result, at least the peripheral or circumferential surface will be exposed to the action of the jet.

The objects forming the basis of the present invention will be attained in respect of the method if this is characterised in that the folding roller is passed into capsule, and that at least the peripheral or circumferential surface of the folding roller is exposed to a jet of cleaning agent under pressure.

The folding roller being rinsed from a short distance and at high pressure interiorly inside a capsule, the advantage will be afforded not only of a good cleaning result, but also that spent or used cleaning agent and adhesive or sealant residues located therein may readily be taken care of.

A further object of the present invention is to realise a cleaning cycle which may be put into effect fully automatically without manual intervention, and also to realise relatively economical and simple equipment.

According to the present invention, this will be attained if the apparatus is given the characterising features as set forth in appended claim 2.

By employing the roll folding machine as a power source and control equipment for the movements of the folding roller in relation to the jet of cleaning agent, a simple and economical apparatus will be realised which may readily be automated and controlled from the roll folding machine.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a perspective view of a manipulator with two folding rollers which are employed in roll folding;

FIG. 2 is a perspective view obliquely from above of a cleaning device according to the present invention;

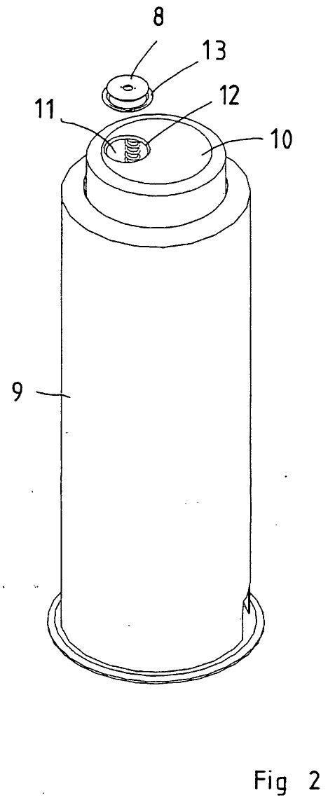

FIG. 3 shows the cleaning device of FIG. 2 with the outer capsule dismounted;

FIG. 4 is a magnified view of an upper region of the cleaning device of FIGS. 2 and 3;

FIG. 5 shows a movement device which is intended to realise a movement in the folding roller when this is cleaned; and

FIG. 6 is a top plan view corresponding to FIG. 4.

### DESCRIPTION OF PREFERRED EMBODIMENT

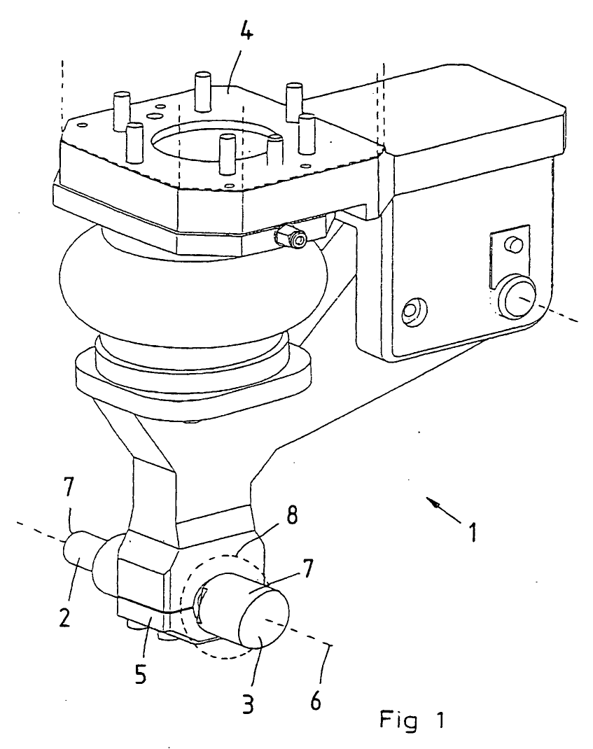

FIG. 1 shows a manipulator 1 which has folding rollers 2 and 3 which are employed in roll folding. The manipulator 1 has an anchorage plate 4 by means of which the manipulator is secured in a tool changer (not shown), which in turn is disposed on a robot which displaces the manipulator 1 along a three-dimensional folding path where one of the two folding rollers 2 and 3 rotates freely in contact with the workpiece.

The folding rollers 2 and 3 which are illustrated in FIG. 1 are freely rotatably journalled about the broken line 6 in an anchorage portion 5 included in the manipulator. The folding rollers are readily replaceable so that an adaptation of the manipulator may easily be put into effect in response to pertinent workpieces. The part of the folding rollers 2 or 3 which primarily becomes fouled by adhesive or sealant is its outer end region 7, for which reason it is particularly important that precisely this end region be reliably cleaned.

Inside the two folding rollers 2 and 3 in FIG. 1, there is disposed a sealing washer 8 which is intimated by the broken line. More details in respect of this sealing washer will be disclosed below.

The cleaning device according to the present invention has an outer casing 9 which, in the illustrated embodiment, is approximately cylindrical but which may have any optional suitable form whatever. The cleaning device is intended to be placed in association with the robot which carries and operates the manipulator 1 in a position which is accurately established in relation to the position of the robot.

At the upper and of the outer casing 9 there is disposed a capsule 10 which is vertically movable against spring action and which has an aperture 11 for insertion of the folding roller 2 or 3 which is to be cleaned.

The aperture 11 has a conically inwardly tapering edge 12 and the above-mentioned sealing washer 8 (FIG. 1) which is placed inside the folding rollers has the corresponding configuration on its periphery so that, when the sealing washer 8 is moved by the robot towards the edge 12 of the aperture, the sealing washer will be guided in by the conical aperture.

Depending on the size of the folding rollers which are to be cleaned, it may be appropriate to place an adapter ring 13 between the sealing washer 8 and the edge 12 of the aperture, the ring being designed to fit against the edge 12 and which has an inner opening which is formed so as to fit together with a smaller sealing washer 8.

As was mentioned by way of introduction, the capsule 10 is movable in the vertical direction a distance that is equal to or greater than the maximum axial length of the folding rollers which are to be cleaned.

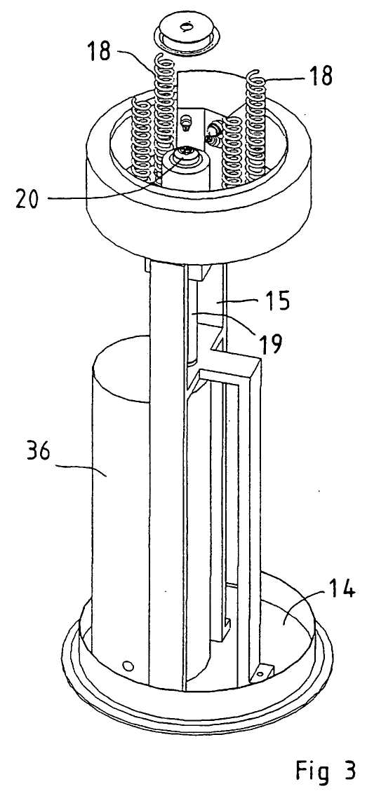

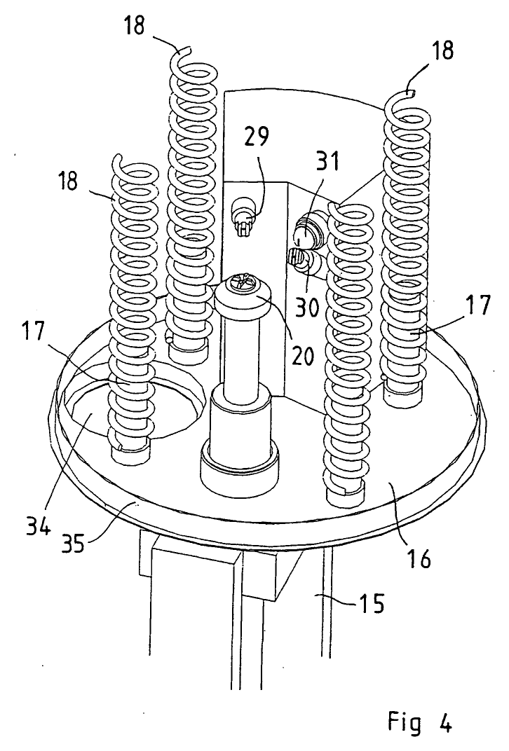

FIG. 3 shows the cleaning device with the outer casing 9 and the capsule 10 removed. It will be apparent from the Figure that the cleaning device has a bottom plate 14 from which a frame 15 extends upwards. The frame 15 has a partition 16 (FIG. 4) in which are secured a number of guide pins 17 for the springs 18 which are intended to keep the capsule 10 raised and to spring pretension it against downward movements. A movement device 19 extends downwards through the partition 16 and has, on its part located above the partition 16, an upwardly projecting rotation or engagement member 20 which is intended to cooperate with the end surfaces of the folding rollers which are to be cleaned. To this end, the end surfaces of the folding rollers have been provided with corresponding engagement members so that, when the engagement member 20 on the movement device 19 is caused to rotate, the folding roller accompanies this rotation movement, on condition that it is held in abutment thereagainst by the robot.

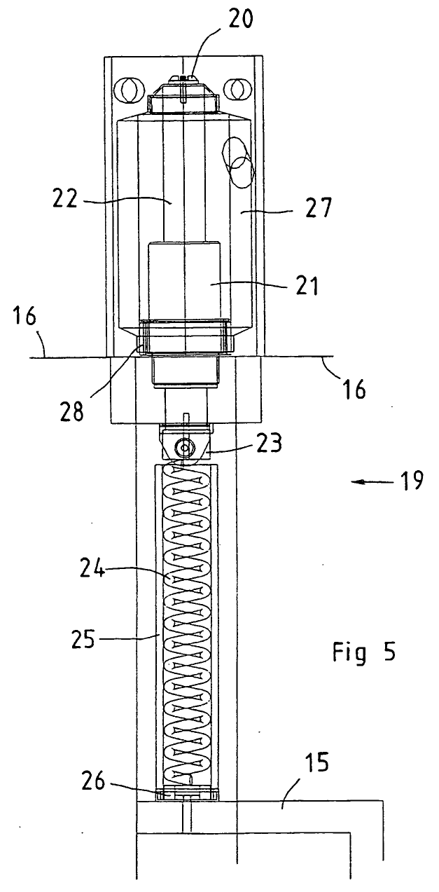

FIG. 5 shows the movement device 19 in greater detail. A nut 21 to a ball bearing screw 22 is non-rotatably secured in the partition 16. The ball bearing screw is, during rotation, movable in its axial direction up and down in the nut 21. The ball bearing screw has, in its upper end facing away from the nut, the above-mentioned engagement member 20 for engagement with an end surface of the folding roller which is to be cleaned. In the lower end 23, the ball bearing screw is in engagement with a spring 24 which is guided in a tube 25. The tube is connected to the upper side of the frame member 15 and has, in its lower end (i.e. on the upper side of the frame member) an axial bearing 26 which permits the spring 24 to rotate in relation to the frame member 15 together with the ball bearing screw 22.

The above-described arrangement entails that, when the engagement member 20 of the robot and the folding roller are depressed in an axial downward direction, the ball bearing screw 22 will, because of the axial movement, be caused to rotate at the same time as the spring 24 is entrained in the rotation and compressed. When the axial pressure against the engagement member 20 is released, the ball bearing screw will, because of the action of the spring 24, rotate in the opposite direction and return to its raised position.

In its simplest form, the present invention entails that the folding roller is cleaned by high pressure rinsing with warm, possibly heated water by high pressure rinsing of the peripheral or circumferential surface of the folding roller and possibly also its free end surface. In such instance, practical trials have demonstrated that a water temperature of the order of magnitude of 80° C. is effective for removing unset adhesive or sealant from the folding roller. A suitable pressure has proved to lie at a level of around 80 bar.

In the cleaning of the folding roller, its one end surface rests on the engagement member 20 on the upper end of the ball bearing screw 22, whereafter the folding roller and the ball bearing screw are rotated and axially displaced downwards by the robot. This entails, with the above-described high pressure rinsing, that the ball bearing screw would run the risk of being exposed—if not directly to the jet—at least to powerful splashing from the rinsing operation. In order to protect the ball bearing screw and its nut from such action, parts of the nut and the ball bearing screw which are located on the upper side of the partition 16 are encapsulated in such a manner that the encapsulation still permits the above-described axial movements in combination with the rotation. In the present embodiment, the encapsulation consists of a bellows 27 which is produced from rubber or other suitable elastic material and which, with its upper end, is non-rotatably fixed to the engagement member 20. The lower end of the bellows 27 is rotatably connected to a collar 28 upwardly directed from the upper side of the partition 16. The described arrangement entails that the bellows 27 may be compressed in the axial direction when the ball bearing screw 22 is displaced downwards, at the same time as its lower end may rotate about the upwardly directed collar 28.

As was intimated above, the peripheral or circumferential surface of the folding rollers is cleaned and preferably also at least certain parts of their outer end surface by rinsing with warm or heated water at high pressure. In the region of the engagement member 20, there are disposed first and second rinsing nozzles 29 and 30 on the upper side of the partition 16, both being designed as multi-jet nozzles. Both of these nozzles 29 and 30 are connected to a source of cleaning agent under high pressure, in the chosen embodiment consisting of water. The first nozzle 29 is directed towards the axis of rotation of the ball bearing screw 22 with the width direction of the jet approximately parallel with the above-mentioned direction of rotation. The second nozzle 30 is placed somewhat lower than the first nozzle 29 and is directed with the width direction of the jet substantially parallel with the axis of rotation of the ball bearing screw. On the other hand, the center line of the jet inclines so that the jet will be split by the edge between the peripheral or circumferential surface of the folding roller and its end surface during the first phase of the downwardly directed movement of the folding roller. An angle of inclination of the order of magnitude of 30-45° may be suitable. Further, the center point lies somewhat under the end surface of the folding roller when this has just been applied against the engagement member 20. A corresponding vertical position for the first nozzle entails that the center line of the jet impinges approximately centrally of or slightly under the center of the axial length of the folding roller if the folding roller is of “average” length.

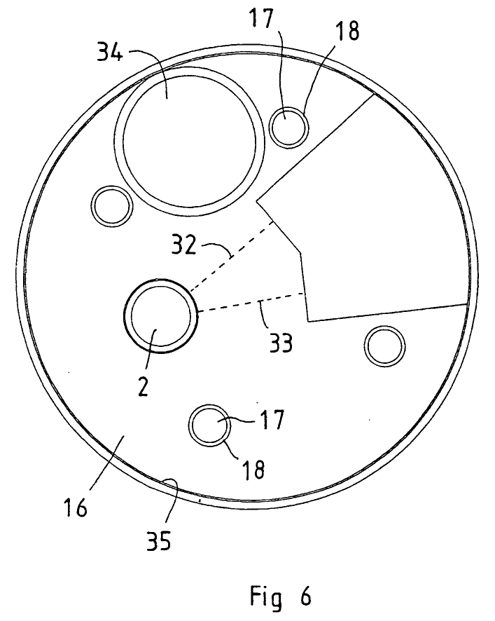

For drying the cleanly rinsed folding roller, there is provided a third nozzle 31 which is connected to a compressed air source. The third nozzle is also directed along a radius in towards the axis of rotation of the ball bearing screw 22. FIG. 6 shows the jet direction of the first nozzle 29 and the jet direction of the compressed air nozzle 31 by means of the two broken lines 32 and 33, respectively.

It will be apparent from FIGS. 4 and 6 that the partition 16 has an aperture 34 which is intended for securing a filter (not shown on the Drawings). Further, the partition 16 has an upwardly directed edge portion 35 so that there is formed, on the upper side of the partition 16, a collection space for used or spent cleaning agent, which subsequently departs through the aperture 34 and the filter down to a collection receptacle 36 (FIG. 3) located beneath the aperture. From the collection receptacle 36, the water is recycled, set at the correct temperature and once against pressurised by means of a high pressure pump from where the water is once again supplied to the two nozzles 29 and 30 in the next cleaning cycle.

The above-described apparatus works as follows. A folding roller which is to be cleaned is brought under the action of the robot which carries the manipulator to a position above the aperture 11 in the outer casing 9. Thereafter, the folding roller is displaced along its axial direction (see the broken line 6 in FIG. 1) down through the aperture and is brought with its engagement member to rotationally fixed engagement with the engagement member 20 on the upper end of the ball bearing screw 22. When engagement has been established and when the ball bearing screw has possibly been displaced but an insignificant distance downwards, the sealing washer 8 disposed on the manipulator seals against the edge 12 of the aperture 11 or, if the adapter 13 is used, against a corresponding edge in its aperture. On further movement of the folding roller in the axial direction of the ball bearing screw 22, the washer 8 presses the capsule 10 down, against the action of the springs 18. At the same time, the rotationally fixed engagement between the end surface of the folding roller and the engagement member 20 on the ball bearing screw entails that the ball bearing screw is moved downwards through the nut 21 at the same time as the ball bearing screw rotates and also the spring 24 is compressed in a downward direction. Just before the downwardly directed movement of the ball bearing screw is commenced, the emission of jets of cleaning agent is commenced from the two nozzles 29 and 30 and is maintained throughout all of the downwardly directed movement of the folding roller. When the folding roller has reached the bottom of its movement pattern, the jets from the two nozzles are shut off at the same time as compressed air is supplied to the third nozzle 31. The pitch of the ball bearing screw is selected in such a manner that the folding roller rotates at least two revolutions on its way in a downward direction. This entails that every point on the peripheral or circumferential surface will be impinged upon by the jets at least twice during one rinsing cycle. During the upwardly directed movement, the peripheral or circumferential surface will also be blown dry at each point, at least twice by the compressed air jet from the nozzle 31.

When the ball bearing screw has reached its upper end position, the folding roller continues in its upwardly directed movement along the direction of rotation of the ball bearing screw a further distance, at least so far that the folding roller is wholly located outside the capsule 10 which has also then assumed its upper end position.

### DESCRIPTION OF ALTERNATIVE EMBODIMENTS

The present invention may be modified in a number of respects, at the same time as its function is maintained in all essentials. It is thus possible to construct the apparatus such that the jet is caused to rotate instead of the folding roller.

The above-described embodiment may also be varied in that the jet of cleaning agent is obliquely directed towards the folding roller which is to be cleaned. In such instance, the jet may then function as a drive means for the folding roller and the angle between the jet and the folding roller is variable for achieving optimum conditions.

The present invention may be further modified without departing from the scope of the appended claims.

1. An apparatus for cleaning a folding roller on a roll folding machine, comprising:
a capsule with an aperture for insertion of the folding roller,
a nozzle which is connected to a high pressure source of cleaning agent and which is directed in order to emit a jet of cleaning agent at least against the peripheral or circumferential surface of the folding roller, and
movement means for realizing a relative movement between the folding roller and the jet so that at least the peripheral or circumferential surface will thereby be exposed to the action of the jet.

2. The apparatus according to claim 1, wherein the movement means includes a screw device which has engagement means for rotationally fixed engagement with the end of the folding roller and which is disposed to impart to the folding roller a rotational movement when the folding roller is displaced axially in engagement with the screw device and in its axial direction.

3. The apparatus according to claim 2, wherein the screw device includes a nut secured in a frame for a ball bearing screw which is spring biased in its length or axial direction and which, in its non-spring biased end, has the engagement means for rotationally fixed engagement with the folding roller.

4. The apparatus according to claim 2, wherein the capsule has a hood with the aperture for insertion of the folding roller; that the hood or casing is disposed to be movable approximately parallel with the axial direction of the screw device and has the aperture in line therewith; and that the hood is spring biased in a direction away from the screw device.

5. The apparatus according to claim 4, further comprising:
a sealing device which is disposed to seal against the aperture after insertion of the folding roller therethrough.

6. The apparatus according to claim 1, wherein the nozzle is a flat jet nozzle which is directed towards the peripheral or circumferential surface of the folding roller along a radius thereto, and with the width direction of the jet substantially parallel with the axial direction of the peripheral or circumferential surface.

7. The apparatus according to claim 1, further comprising:
a second flat jet nozzle which is directed at least partly towards an end surface on the folding roller and with the width direction of the jet substantially in a plane which also encompasses the axial direction of the folding roller.

8. The apparatus according to claim 3, wherein a protective bellows is disposed about the ball bearing screw and at least partly about its nut, the one end of the bellows being secured in the ball bearing screw in the region of its engagement member while the opposite end is rotatably secured in the frame in the region of the anchorage of the nut therein.

9. The apparatus according to claim 3, wherein the frame has a collection tray in which the nut is secured; and that there is disposed, in the collection tray, a filter through which spent cleaning agent departs for recycling to the high pressure source.

10. The apparatus according to claim 1, further comprising:
a drying nozzle which is connected to a compressed air source and which is directed towards the folding roller for drying thereof.

11. A method of cleaning a folding roller in a roll folding machine, comprising:
passing the folding roller into a capsule; and
exposing at least the peripheral or circumferential surface of the folding roller to a jet of cleaning agent under pressure

12. The method according to claim 11, wherein the folding roller is caused, in the capsule, to move in relation to the jet.

13. The method according to claim 11, wherein the folding roller is caused, in the capsule, to rotate in relation to the jet.

14. The method according to claim 11, wherein the folding roller is, in the capsule, subjected to an axial movement in relation to the jet.

15. The method according to claim 11, wherein the jet is given a flat configuration and is directed along a radius to the peripheral or circumferential surface.

16. The method according to claim 11, further comprising:
subjecting the folding roller to a second jet of cleaning agent under pressure, the second jet being directly at least partly towards an end surface of the folding roller.

17. The method according to claim 11, wherein use is made as cleaning agent of warm, possibly heated water.

18. The method according to claim 11, wherein the cleaning agent is filtered and re-used.

19. The method according to claim 11, wherein a jet of compressed air is directed towards the peripheral or circumferential surface for drying thereof.
